(19) United States
(12) Patent Application Publication
(10) Pub. No.: US 2026/0027626 A1
(43) Pub. Date: Jan. 29, 2026

(54) TOOL AND METHOD FOR MACHINING A WORKPIECE

(71) Applicant: Hartmetall-Werkzeugfabrik Paul Horn GmbH, Tübingen (DE)

(72) Inventors: Markus Kannwischer, Ergenzingen (DE); Matthias Luik, Reutlingen (DE)

(73) Assignee: Hartmetall-Werkzeugfabrik Paul Horn GmbH, Tübingen (DE)

(21) Appl. No.: 19/345,640

(22) Filed: Sep. 30, 2025

Related U.S. Application Data
(63) Continuation of application No. PCT/EP2024/057593, filed on Mar. 21, 2024.

(30) Foreign Application Priority Data
Mar. 30, 2023 (DE) 10 2023 108 122.5

(51) Int. Cl. B23B 27/16

(52) U.S. Cl. CPC B23B 27/16

(57) ABSTRACT

A tool for machining a workpiece includes a tool holder, which extends along a holder longitudinal axis, and a cutting insert, which can be mounted on the tool holder with a mounting element. An extension is arranged on the cutting insert and projects from a support surface on the cutting insert. The extension, when in the mounted state of the tool, engages in a recess provided on the tool holder. The recess is formed in a support surface on the holder. Three insert-side bearing surfaces, which are arranged transversely to one another, are arranged laterally on the extension and two of them, in the mounted state of the tool, rest against two holder-side bearing surfaces, which form side walls of the recess. In the mounted state of the tool, the cutting insert rests with its insert-side support surface against the holder-side support surface of the tool holder.

### CROSS-REFERENCE TO RELATED APPLICATIONS

This application is a continuation of international patent application PCT/EP2024/057593, filed on Mar. 21, 2024 designating the U.S., which international patent application has been published in German language and claims priority from German patent application DE 10 2023 108 122.5, filed Mar. 30, 2023. The entire contents of these priority applications are incorporated herein by reference.

### BACKGROUND

This disclosure relates to a tool for machining a workpiece, comprising a tool holder and a cutting insert, which can be mounted on the tool holder by means of a mounting element.

The herein presented tool is configured in particular as a turning tool, particularly preferably as a tool for profile turning.

Generic tools for profile turning are already known in principle in numerous forms. Exemplary cutting inserts for such profile turning tools are marketed by the applicant under the name “profiling inserts S117”.

Profile turning is a well-known turning process standardized according to DIN 8589 under reference number 3.2.1.5 and used to create rotationally symmetrical shapes on workpieces. In profile turning, the shape to be created on the workpiece is formed as a negative on the tool or the cutting insert of the tool. The cutting inserts for such tools are therefore usually custom-made, with the shape to be created on the workpiece ground as a negative into the cutting contour of the cutting insert. Exceptions are standardized profile turning tools for creating grooves, undercuts, or round profiles.

The general advantage of such profile turning tools is that the profile to be reproduced on the workpiece can be created in a single operation. Otherwise, the production of such profiles would usually require several different tools with differently shaped cutting edges, each of which would produce only individual segments of the profile to be created. Profile turning is therefore highly productive and offers short machining times, even for more complex shapes.

In profile turning, a basic distinction is made between longitudinal and transverse profile turning, between internal and external profile turning, and between grooving and parting-off profile turning.

The cutting inserts of such profile turning tools are used in either a horizontal or vertical position depending on the tool design.

The cutting insert mentioned above, which is marketed by the applicant under the name “profiling inserts S117,” is a cutting insert that is used in a horizontal position. This means that it is arranged horizontally on the tool holder. It therefore lies flat on the tool holder with one of its two transverse sides, which are comparatively larger than the narrow sides of the cutting insert. The extension of the cutting insert measured parallel to the cutting direction is accordingly smaller than its extension measured orthogonally in the infeed and/or feed direction.

In a vertical arrangement of the cutting insert, however, the cutting insert is arranged upright on the tool holder, with the cutting edges used being arranged on the narrow sides of the cutting insert and the extension of the cutting insert in the cutting direction typically being greater than its extension in the infeed and/or feed direction.

Due to these completely different geometries of “horizontal” and “vertical” cutting inserts, the way in which the cutting inserts are attached to the tool holder as well as their intended use are completely different. For larger cutting widths, for example, those greater than 20 mm, only tools with “horizontal” cutting inserts are generally used since tools with “vertical” cutting inserts would result in very large-format cutting inserts, which would result in extremely high carbide consumption. Even for machining operations with comparatively limited space requirements, such as turning in bores, only “horizontal” inserts are typically used. Since the space required for internal bore machining is limited by the bore radius, comparatively flat inserts must be used. The use of “horizontal” cutting inserts is therefore significantly more advantageous for this application than the use of “vertical” cutting inserts.

In order to ensure reliable machining with clearly repeatable machining results, a stable and clearly repeatable method of clamping the cutting inserts in the tool holder is also of immense importance. In order to ensure a stable insert seat, it is therefore particularly important to have an interface between the cutting insert and the tool holder that is configured to suit the specific application.

In various tool systems for profile turning known to date, this fundamental problem of securely clamping the cutting insert to the tool holder has not been satisfactorily solved. For example, the loads occurring during machining can lead to undesirable relative movements between the cutting insert and the tool holder. However, this must be absolutely eliminated to achieve the desired machining quality.

Furthermore, from an economic perspective, it would be desirable to design such cutting inserts for profile turning as indexable inserts with a plurality of identical cutting edges, allowing the same cutting insert to be used multiple times by clamping it to the tool holder in different orientations. If one of the cutting edges wears out, such indexable inserts can be released from the tool holder and then re-clamped in the tool holder in a different position, in which a different cutting edge that is not yet worn out is used.

### SUMMARY

It is an object to provide a tool for machining a workpiece that eliminates or at least largely overcomes the aforementioned disadvantages. In particular, it is an object to provide a tool for machining a workpiece in which the interface used to clamp the cutting insert to the tool holder is structurally improved in order to allow for a stable insert seat, and in which the cutting insert is configured as an indexable insert with a plurality of cutting edges that can be used one after the other.

This object is achieved according to the invention by a tool according to claim 1, in which the tool holder has a cutting insert receptacle in a side surface for receiving the cutting insert, which comprises a recess formed in a support surface on the holder. A base of the recess is penetrated by a holder-side mounting bore, wherein a bore axis of the holder-side mounting bore extends transversely to the holder longitudinal axis and wherein the holder-side mounting bore serves to receive the mounting element. The recess is delimited laterally by two holder-side bearing surfaces arranged transversely to the base and arranged transversely to one another. The cutting insert has a plurality of identical cutting edges, which are arranged in a common cutting plane, are formed at a transition between an upper side and a peripheral side of the cutting insert, are arranged at an angular offset from one another and extend transversely to one another. On a lower side opposite the upper side, the cutting insert has an insert-side support surface, which is arranged parallel to the cutting plane. Furthermore, the cutting insert has an extension, which projects from the insert-side support surface and, in a mounted state of the tool, is inserted in the recess and on which three insert-side bearing surfaces aligned transversely to one another are arranged laterally. The cutting insert further comprises an insert-side mounting bore extending centrally through the extension and penetrating the upper side and the lower side, the bore axis of which mounting bore is arranged orthogonally to the cutting plane and serves to receive the mounting element. In the mounted state of the tool, the insert-side support surface rests against the holder-side support surface. In the mounted state of the tool, a first of the three insert-side bearing surfaces rests against a first of the two holder-side bearing surfaces. In the mounted state of the tool, a second of the three insert-side bearing surfaces rests against a second of the two holder-side bearing surfaces.

The tool thus has a cutting insert that is arranged horizontally on the tool holder. This cutting insert is configured as an indexable insert, which has a plurality of identical cutting edges arranged at an angular offset from one another at the transition between the upper side and the peripheral side of the cutting insert.

In other words, the cutting insert of the tool has at least two identical cutting edges. Preferably, the tool has at least three identical cutting edges. Particularly preferably, the tool has exactly three identical cutting edges. Depending on the design, however, the cutting insert of the tool can also comprise four, five, six or more identical cutting edges, all of which lie in a common cutting plane.

The cutting insert of the tool is preferably configured to be rotationally symmetrical about the bore axis of the insert-side mounting bore. The cutting edges of the cutting insert are accordingly preferably offset from one another by a constant angle. In other words, one of these cutting edges can be aligned with another of these cutting edges by rotating it by a constant angle about the bore axis of the insert-side mounting bore. The particular angle of rotation depends on the number of cutting edges and results from the quotient of 360° divided by the number of identical cutting edges.

In the preferred embodiment of the cutting insert with exactly three identical cutting edges, these cutting edges can thus be aligned with one another by rotating them 120° about the bore axis of the insert-side bore. According to this preferred embodiment, the cutting insert is preferably 120° rotationally symmetrical as a whole about the bore axis of the insert-side mounting bore.

The number of insert-side bearing surfaces preferably corresponds to the number of cutting edges provided on the cutting insert. The insert-side bearing surfaces are also preferably arranged at an angular offset from one another by a constant angle (for example) 120° about the bore axis of the insert-side mounting bore.

Furthermore, it should be noted that the term “transverse” does not necessarily mean orthogonal, but rather any spatial alignment of two structures (e.g., surfaces or cutting edges) that form an angle greater than 0° between them, i.e., are not parallel to one another.

For example, in the tool according to the disclosure, the bore axis of the holder-side mounting bore extends transversely, i.e., not parallel, but preferably orthogonally to the holder longitudinal axis. The two holder-side bearing surfaces extend transversely, i.e., not parallel, but preferably orthogonal to the base of the recess. The two holder-side bearing surfaces are aligned transversely, i.e., not parallel, but preferably at an acute angle to one another. The cutting edges arranged on the cutting insert extend transversely, i.e., not parallel, to one another and preferably form an acute angle between them. The same applies to the (at least) three insert-side bearing surfaces.

The interface between the cutting insert and the cutting insert receptacle provided on the tool holder offers various technical advantages.

As a result of the horizontal arrangement of the cutting insert, which is achieved by the cutting insert resting flat against the holder-side support surface with its insert-side support surface arranged on the lower side and aligned parallel to the cutting plane, a very flat and space-saving design can be achieved. This allows the tool to be used even in confined machining situations, for example, for machining internal bores.

The two support surfaces (the insert-side and the holder-side support surface) are typically aligned orthogonally to the cutting direction during turning. Accordingly, the majority of the cutting force is introduced into the tool holder at the contact point between these two support surfaces.

Since these two support surfaces can be configured to be comparatively large due to their geometry, the force introduction can be distributed over a comparatively large area, thereby reducing the contact pressure between the cutting insert and the tool holder caused by the cutting force.

The machining forces acting transversely thereto during turning (e.g., feed force and passive force) are substantially absorbed by the holder-side bearing surfaces and the corresponding insert-side bearing surfaces.

In this regard, it is advantageous that the bearing surfaces and the support surfaces are arranged on different parts of the cutting insert or on different parts of the cutting insert receptacle, which are structurally and spatially separated from one another.

The holder-side bearing surfaces are formed by the side walls of the recess formed in the holder-side support surface. The insert-side bearing surfaces are arranged laterally on the extension projecting from the insert-side support surface. This separation of the bearing surfaces and support surfaces has a positive effect on the mechanical stability of the insert seat. In particular, this can effectively prevent load-related relative movement between the cutting insert and the tool holder that occurs during machining.

The structural and spatial separation of the support surfaces and bearing surfaces also makes it possible for the recess provided in the cutting insert receptacle and the corresponding extension on the cutting insert to be comparatively small, which also makes a space-saving overall arrangement possible. If the support surfaces intended to absorb the cutting forces were also arranged in the recess or on the extension, the recess and extension would have to be significantly larger or more solid.

According to a refinement, the insert-side support surface completely surrounds the extension. This means that the insert-side support surface does not surround only part of the extension, but surrounds the extension along its entire perimeter.

This has a hugely positive effect on the mechanical stability of the insert seat. On the one hand, this allows the size of the insert-side support surface to be increased. On the other hand, it effectively prevents load-related tilting of the cutting insert since the cutting insert is supported all around the extension.

In a refinement, the holder-side support surface completely surrounds the recess. This means that the holder-side support surface does not surround only part of the recess, but surrounds the recess along its entire perimeter.

This also has a positive effect on the mechanical stability of the insert seat since the tool holder can support the lower side of the cutting insert along the entire perimeter of the recess. Furthermore, it prevents parts of the recess from breaking out, since the recess is completely formed in the solid part of the tool holder.

Preferably, the holder-side support surface and the insert-side support surface are each configured as a planar surface. Likewise, the holder-side bearing surfaces and the insert-side bearing surfaces are each preferably configured as a planar surface. This allows for a defined, flat support or contact of the cutting insert on the tool holder.

According to a further refinement, a cross section of the extension aligned orthogonally to the bore axis of the insert-side mounting bore has substantially the shape of a regular polygon with rounded corners. In the case of a 120° rotationally symmetrical cutting insert, the cross section of the extension preferably corresponds substantially to the shape of an equilateral triangle with rounded corners.

This refinement has the advantage that the insert-side bearing surfaces arranged on the extension are provided as regular surfaces corresponding to the cutting edges of the cutting insert.

In a refinement of the cutting insert with exactly three cutting edges, it is therefore preferred according to one embodiment that the insert-side bearing surfaces form an angle of 60° between them, as is also the case with an equilateral triangle. Preferably, the holder-side bearing surfaces also form an angle of 60° between them according to this embodiment.

According to a further refinement, the bore axis of the insert-side mounting bore is arranged orthogonally to the holder longitudinal axis.

If the bore axis is arranged orthogonally to the cutting plane, the cutting plane extends parallel to the holder longitudinal axis.

In a further refinement, a height of the extension measured parallel to the bore axis of the insert-side mounting bore is smaller than a depth of the recess measured parallel to the bore axis of the holder-side mounting bore.

Accordingly, the cutting insert rests perpendicularly to the bore axis only with the insert-side support surface against the holder-side support surface. However, the extension projecting from the insert-side support surface does not touch the base of the recess. This creates a mechanically clearly defined support for the cutting insert.

In a further refinement, the extension has a planar end face, which extends transversely to the insert-side bearing surfaces, is penetrated by the bore and is arranged orthogonally to the bore axis of the insert-side mounting bore.

The insert-side mounting bore preferably extends centrally through the extension and thus also centrally through the planar end face.

In a further refinement, the two holder-side bearing surfaces are each at a first distance from the bore axis of the holder-side mounting bore, wherein the recess is further delimited laterally by a side surface extending transversely to the base and transversely to the two holder-side bearing surfaces, which side surface is at a second distance from the bore axis of the holder-side mounting bore that is greater than the first distance.

Said side surface also forms a side wall of the recess. However, unlike the two holder-side bearing surfaces, which form the other side walls of the recess, said side surface is at a greater distance from the bore axis of the holder-side mounting bore. A cross section of the recess aligned orthogonally to the bore axis of the holder-side mounting bore is substantially the shape of an isosceles triangle with rounded corners.

This ensures that, in the mounted state of the tool, only two of the three insert-side bearing surfaces rest against the tool holder or the holder-side bearing surfaces. The third insert-side bearing surface, however, is spaced from said side surface of the recess in the mounted state of the tool.

It is understood that this third insert-side bearing surface, which has no contact with the tool holder, can be a different one of the three insert-side bearing surfaces depending on how the cutting insert is mounted on the tool holder (i.e., which of the plurality of cutting edges is used). Accordingly, all three surfaces are referred to here as insert-side bearing surfaces, although according to this refinement, only two of the three insert-side bearing surfaces rest against the tool holder in the mounted state.

According to the latter refinement, the recess is designed somewhat larger than the extension arranged on the cutting insert and acting as a counterpart thereto. More precisely, a cross section of the recess aligned orthogonally to the bore axis of the holder-side mounting bore is larger than a cross section of the extension aligned orthogonally to the bore axis of the insert-side mounting bore.

This makes it easier to insert the extension into the recess. In addition, this creates a precisely defined surface contact on the two engaging insert-side bearing surfaces.

In a further refinement, in the mounted state of the tool, a first of the plurality of cutting edges is arranged in a region of the cutting insert projecting laterally from the tool holder, wherein the first cutting edge is at a shorter distance from the side surface than from the two holder-side bearing surfaces.

This so-called “first cutting edge” is the cutting edge of the cutting insert that is (currently) used for machining. The cutting insert thus rests against the tool holder with its two insert-side bearing surfaces that are at the greatest distance from the cutting edge used for machining. This also further improves the mechanical stability of the insert seat. The cutting insert is, in effect, drawn into the tool holder away from the active cutting edge.

In a further refinement, a height of the extension measured parallel to the bore axis of the insert-side mounting bore is less than 40% of a total height of the cutting insert measured parallel thereto. Particularly preferably, this height of the extension is less than 35% of the total height of the cutting insert. In particular, it is preferred that the height of the extension is 25-35% of the total height of the cutting insert.

The extension therefore has a comparatively low height. Accordingly, a comparatively flat cutting insert can be realized despite the extension arranged on the cutting insert. This preserves the suitability of the cutting insert for machining in confined spaces.

In a further refinement, the cutting insert receptacle is arranged in a cut-out provided on the tool holder, which cut-out has a side wall, which partially surrounds the holder-side support surface, is arranged transversely to the holder-side support surface and, in the mounted state of the tool, surrounds two of the plurality of cutting edges of the cutting insert.

This cut-out is larger than the recess in the holder-side support surface since it at least partially surrounds the holder-side support surface. The side wall of this cut-out serves in particular to protect the two inactive cutting edges of the cutting insert so that they are not damaged before they are used as active cutting edges for machining.

It is understood that the features mentioned above and those to be explained below can be used not only in the combination specified in each case, but also in other combinations or on their own without departing from the spirit and scope of the present disclosure.

### BRIEF DESCRIPTION OF THE DRAWINGS

FIG. 1 is a perspective view of an exemplary embodiment of the tool;

FIG. 2 is a plan view from above of the tool shown in FIG. 1 together with a sectioned workpiece being machined by means of the tool;

FIG. 3 is an exploded view of the tool shown in FIG. 1;

FIG. 4a-4d are various views of a cutting insert usable in the tool of FIG. 1 according to a first exemplary embodiment;

FIG. 5a-5d are various views of a cutting insert usable in the tool of FIG. 1 according to a second exemplary embodiment;

FIG. 6a-6b show a tool holder of the tool shown in FIG. 1 in a perspective view (FIG. 6a) and in a plan view from above (FIG. 6b);

FIG. 7 is a partial longitudinal sectional view of the tool shown in FIG. 1;

FIG. 8 is a partial longitudinal sectional view of the tool holder shown in FIGS. 6a and 6b; and

FIG. 9 is a longitudinal sectional view of the cutting insert shown in FIG. 4a-4d.

### DESCRIPTION OF PREFERRED EMBODIMENTS

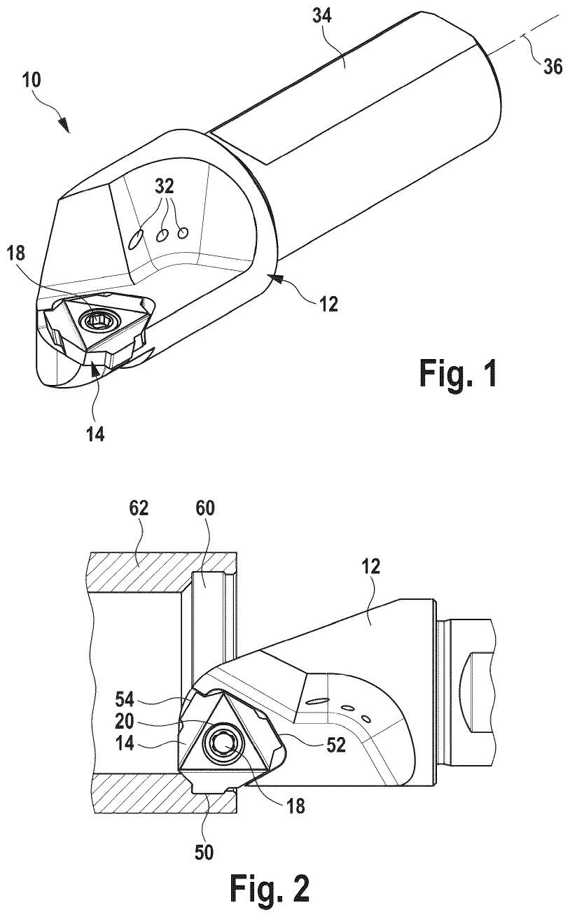

FIG. 1 shows an exemplary embodiment of the tool in a perspective view. The tool is denoted in its entirety by reference sign 10.

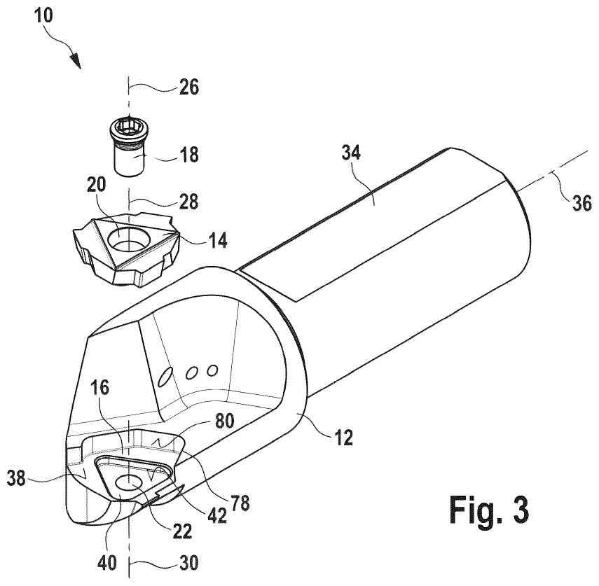

The tool 10 comprises a tool holder 12 and a cutting insert 14 releasably mounted on the tool holder 12. The cutting insert 14 is mounted in a cutting insert receptacle 16, which is arranged in the region of a front end of the tool holder 12 and is inserted in one of the side surfaces of the tool holder 12, by means of a mounting screw 18 (see FIG. 3).

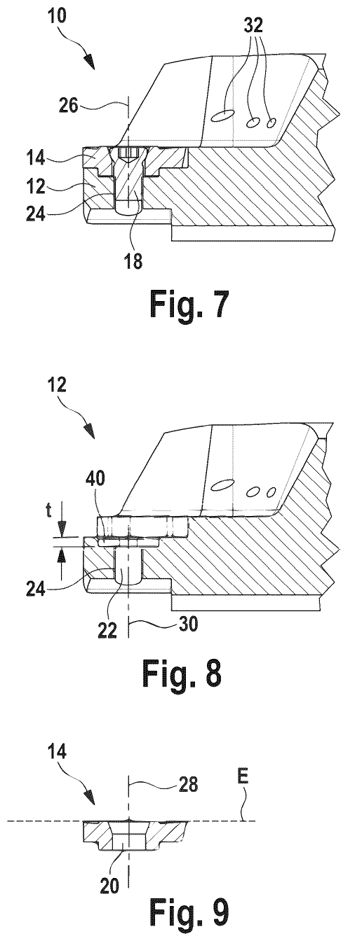

In the mounted state of the tool 10, the mounting screw 18 extends through a mounting bore 20, which is arranged centrally in the cutting insert 14 and is referred to herein as the insert-side mounting bore 20, and is inserted in a mounting bore 22 provided in the tool holder 12, which mounting bore is provided with a thread 24 corresponding to the mounting screw 18 and is referred to herein as the holder-side mounting bore 22, and is screwed to the thread 24 (see FIG. 7).

As can be seen in particular in FIG. 2, the mounting screw 18 is arranged eccentrically in the insert-side mounting bore 20 in the mounted state of the tool 10. In other words, the longitudinal axis 26 of the mounting screw 18 is slightly offset from the bore axis 28 of the insert-side mounting bore 20. However, the longitudinal axis of the mounting screw 18 coincides with the bore axis 30 of the holder-side mounting bore 22. Accordingly, the bore axis 28 of the insert-side mounting bore 20 is also offset laterally by a few tenths (e.g., by 0.1 mm-0.2 mm) parallel to the bore axis 30 of the holder-side mounting bore 22 in the mounted state of the tool 10. This ensures that the mounting screw 18 causes the cutting insert 14 to experience not only an axial tightening force acting along the longitudinal axis 26 of the mounting screw 18, but also a tightening force acting transversely thereto, with which the cutting insert 14 is drawn into the cutting insert receptacle 16.

In the embodiment shown here, a plurality of internal coolant channels is arranged in the tool holder 12, which cooling channels open into a plurality of coolant outlets 32 aligned with the cutting insert 14 in order to supply it with coolant/lubricant during machining. The coolant channels, not explicitly shown here, preferably extend inside the tool holder 12 through a clamping portion 34 arranged on the rear side of the tool holder 12. This clamping portion 34 serves to clamp the tool 10. The typically elongated clamping portion 34 extends along the longitudinal axis 36 of the tool holder 12.

The cutting insert receptacle 16, arranged on the front side of the tool holder 12 opposite the clamping portion 34, has a planar surface 38, which is arranged parallel to the holder longitudinal axis 36 and is referred to herein as the holder-side support surface 38. A recess 40 is formed in this holder-side support surface 38. This recess 40 is delimited at the bottom by a base 42, which is arranged parallel to the holder-side support surface 38 and is arranged offset therefrom. The holder-side mounting bore 22 extends perpendicularly through this base 42 of the recess 40.

The recess 40 is delimited laterally by three planar surfaces 44, 46, 48. These three surfaces 44, 46, 48 form the side walls of the recess 40 and are each aligned transversely, preferably orthogonally, to the base 42 of the recess 40.

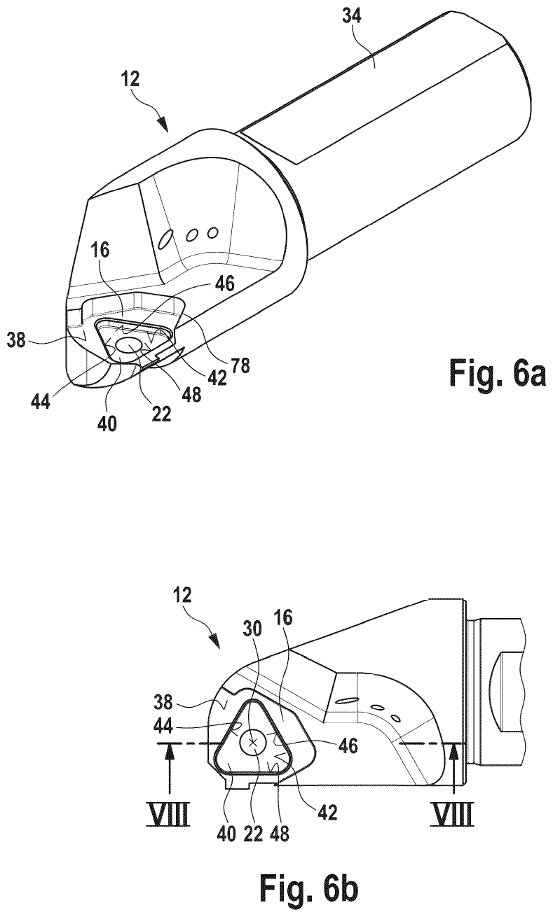

As can be seen in particular in FIG. 6b, a cross section of the recess 40 aligned orthogonally to the bore axis 30 of the holder-side mounting bore 22 is substantially the shape of an isosceles triangle with rounded corners, with the three mentioned surfaces 44, 46, 48 forming the three sides of the isosceles triangle in this cross section.

As explained in detail below, only two of these three surfaces 44, 46, 48 act as lateral bearing surfaces against which the cutting insert 44 rests in the mounted state of the tool 10. More precisely, these bearing surfaces are surfaces 44 and 46. In the present case, therefore, surface 44 is referred to as the first holder-side bearing surface 44 and surface 46 is referred to as the second holder-side bearing surface 46, while surface 48 is referred to as the side surface 48 of the recess 40.

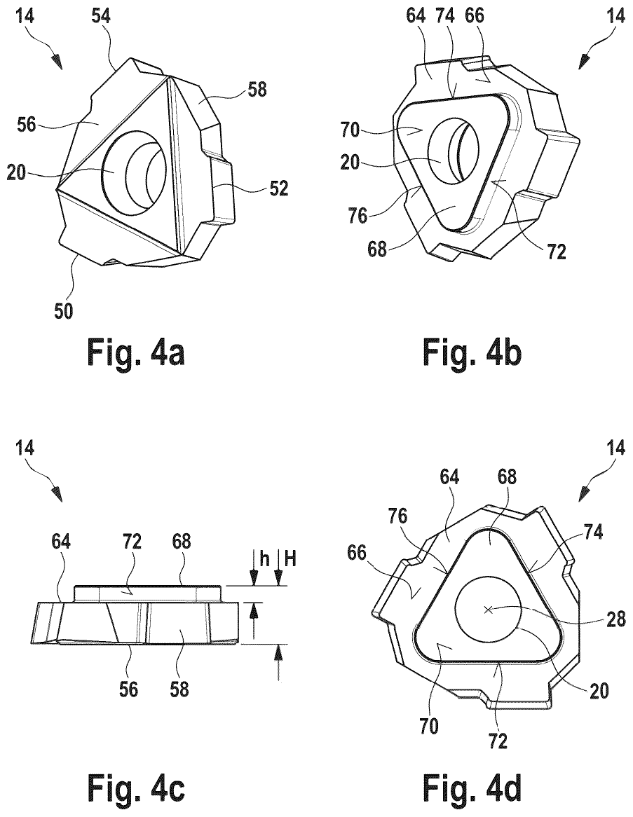

A first embodiment of the cutting insert 14 of the tool 10 is shown in various views in FIG. 4a-4d and in FIG. 9. FIG. 4a shows the upper side of the cutting insert 14 in a perspective view. FIG. 4b shows the lower side of the cutting insert 14 in a perspective view. FIG. 4c is a side view of the cutting insert 14. FIG. 4d is a plan view of the lower side of the cutting insert 14. FIG. 9 is a sectional view of the cutting insert 14, with the cutting plane extending along the bore axis 28 of the insert-side mounting bore 20.

The cutting insert 14 is configured as an indexable insert. The cutting insert 14 is 120° rotationally symmetrical to the bore axis 28 of the insert-side mounting bore and has three identically formed cutting edges 50, 52, 54. All three cutting edges 50, 52, 54 are each formed at the transition between the upper side 56 and the peripheral side 58. The three cutting edges 50, 52, 54 lie in a common cutting plane E. The cutting plane E is indicated with a dashed line in FIG. 9.

Each of these three cutting edges 50, 52, 54 has a cutting edge contour which corresponds to the negative of a profile to be produced on a workpiece by means of the tool 10. Such a profile 60 is shown schematically in FIG. 2. The profile 60 shown in FIG. 2, which is produced on a workpiece 62 by means of the tool 10, corresponds here to an internal profile that is introduced into a bore in the workpiece 62.

A special feature of the production of this profile 60 by means of the tool 10 is that this profile 60 is introduced into the workpiece 62 in only one operation by means of one and the same tool 10. In order to ensure this, the cutting edge contour of each of the three cutting edges 50, 52, 54 is precisely adapted to the shape of the profile 60 to be produced. Accordingly, each of the three cutting edges 50, 52, 54 has a plurality of cutting edges aligned transversely to one another.

In the present embodiment, the cutting edges of the cutting edges 50, 52, 54 are each configured as straight cutting edges. However, it is understood that one or more of these cutting edges may also be configured as curved cutting edges, depending on the profile to be produced. It is also understood that the cutting insert 14 can be used not only for internal profile turning but also for external profile turning.

On the lower side 64 opposite the upper side 56, the cutting insert 14 has a planar support surface 66, which is referred to herein as the insert-side support surface 66. This insert-side support surface 66 extends orthogonally to the bore axis 28 of the insert-side mounting bore 20 and parallel to the cutting plane E.

Furthermore, the cutting insert 14 has an extension 68 on its lower side 64, which extension projects from the insert-side support surface 66. This extension 68 acts as a counterpart to the recess 40 formed in the cutting insert receptacle 16. The insert-side mounting bore 20 extends centrally through this extension 68. An end face 70 of the extension 68 is configured as a planar surface, which is penetrated by the insert-side mounting bore 20 and is arranged orthogonally to the bore axis 28 of the insert-side mounting bore 20.

Furthermore, three surfaces 72, 74, 76 are arranged laterally on the extension 68 and are aligned transversely to one another, which surfaces are referred to here as the first insert-side bearing surface 72, the second insert-side bearing surface 74 and the third insert-side bearing surface 76. In the present embodiment, these three insert-side bearing surfaces 72, 74, 76 are aligned at an angle of 60° to one another. They extend orthogonally to the insert-side support surface 66 and parallel to the bore axis 28 of the insert-side mounting bore 20. All three insert-side bearing surfaces 72, 74, 76 are at the same distance from the bore axis 28 of the insert-side mounting bore 20.

While the recess 40 is the shape of an isosceles triangle with rounded edges in cross section, the extension 68 arranged on the cutting insert 14 is the shape of an equilateral triangle with rounded corners in a cross section aligned orthogonally to the bore axis 28.

The height of the extension 68 is comparatively small compared to the total height of the cutting insert 14. Preferably, a height h of the extension measured parallel to the bore axis 28 is less than 40%, particularly preferably less than 30%, of the height h of the cutting insert 14 measured parallel thereto (see FIG. 4c).

In addition, the height h of the extension 68 arranged on the cutting insert 14 is smaller than a depth t of the recess 40 measured parallel to the bore axis 30 of the holder-side mounting bore 22 (see FIG. 8). As a result, the end face 70 of the extension 68 does not rest against the base 42 of the recess 40 in the mounted state of the tool (see FIG. 7).

Instead, in the mounted state of the tool 10, the cutting insert 14 rests with its insert-side support surface 66 according to the first embodiment of the cutting insert 14 flat against the holder-side support surface 38 (see FIG. 7). In addition, according to the first embodiment, in the mounted state of the tool 10, the cutting insert 14 rests with two of its three insert-side bearing surfaces 72, 74, 76 against the holder-side bearing surfaces 44, 46.

Since the cross-sectional area of the recess 40 is larger than the cross-sectional area of the extension 68, the third of the three insert-side bearing surfaces 72, 74, 76, which in the mounted state of the tool 10 lies opposite the side surface 48 of the recess 40, is spaced from the side surface 48 and thus does not rest against it. This is due in particular to the fact that the two holder-side bearing surfaces 44, 46 are at a first distance from the bore axis 30 of the holder-side mounting bore 22, while the side surface 48 is at a second distance from the bore axis 30 that is greater than the first distance.

As can be seen in particular in FIGS. 4d and 6b, the insert-side support surface 66 according to the first embodiment of the cutting insert 14 surrounds the entire perimeter of the extension 68. Likewise, the holder-side support surface 38 surrounds the entire perimeter of the recess 40. This allows for an extremely stable support of the cutting insert 14, which in particular prevents load-dependent tilting of the cutting insert 14.

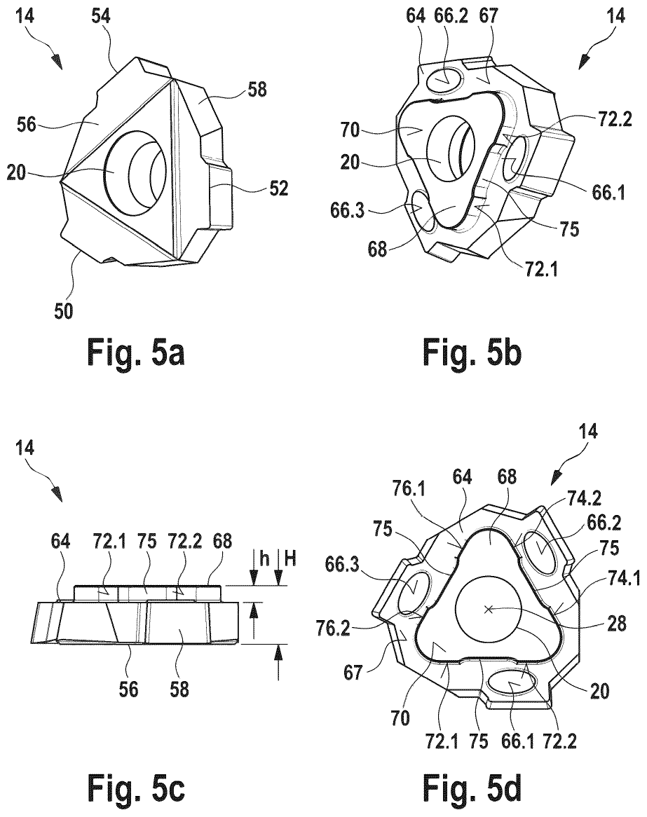

FIG. 5a-5d show a second embodiment of the cutting insert 14 in four different views, which correspond to the views of FIG. 4a-4d. In contrast to the first embodiment shown in FIG. 4a-4d, the cutting insert 14 according to the second embodiment shown in FIG. 5a-5d is configured as a sintered cutting insert, which has some design differences due to the manufacturing process.

Firstly, a plurality of elevations, on the end faces of which a portion of the insert-side support surface 66 is formed, is arranged on the lower side 64 of the cutting insert. The insert-side support surface 66 is thus divided into three segments 66.1, 66.2, and 66.3, which are distributed along the lower side 64 of the cutting insert 14. Each of these three segments has a planar surface, which surfaces lie in a 20 common support plane and together form the insert-side support surface 66. In other words, the cutting insert 14 here has three support surfaces 66.1, 66.2, 66.3. In contrast to the cutting insert 14 shown in FIG. 4a-4d, the cutting insert 14 shown in FIG. 5a-5d, in the mounted state of the tool 10, does not rest on the holder-side support surface 38 with its entire surface, which is denoted here by reference sign 67, but rather with the three support surfaces 66.1, 66.2, 66.3.

Furthermore, a recess 75 is formed in each of the insert-side bearing surfaces 72, 74, 76 arranged laterally on the extension 68. The insert-side bearing surfaces 72, 74, and 76 are thus also segmented into two segments, 72.1, 72.2, 74.1, 74.2, and 76.1, 76.2, respectively. The two segments 72.1, 72.2 or 74.1, 74.2 or 76.1, 76.2 of each bearing surface 72, 74, 76 are spaced apart from one another, lie in one plane and are in each case separated by one of the recesses. In other words, one could also say that the cutting insert has two first insert-side bearing surfaces 72.1, 72.2, two second insert-side bearing surfaces 74.1, 74.2 and two third insert-side bearing surfaces 76.1, 76.2.

In the mounted state of the tool 10, the cutting insert 14 rests with both segments 72.1, 72.2 or 74.1, 74.2 or 76.1, 76.2 of the relevant insert-side bearing surface 72, 74, 76 against the relevant holder-side bearing surface 44 or 48. For example, the two segments 72.1, 72.2 rest against the first holder-side bearing surface 44 and the two segments 74.1, 74.2 rest against the second holder-side bearing surface 48.

The three insert-side support surfaces 66.1, 66.2, 66.3 are arranged on different sides of the extension 68. In other words, each of these three support surfaces 66.1, 66.2, 66.3 is geometrically assigned to one of the three insert-side bearing surfaces 72, 74, 76. Thus, the cutting insert 14 according to the second embodiment shown in FIG. 5a-5d results in a type of three-point support, which ensures a similarly stable insert seat as in the case of the cutting insert 14 according to the first embodiment.

Regardless of the type of design of the cutting insert 14, the cutting insert receptacle 16 is arranged as a whole in a cut-out 78, which is provided on the tool holder 12 and is delimited laterally by a side wall 80, which partially surrounds the holder-side support surface 38 and is arranged transversely thereto. The cut-out 78 or its side wall 80 has the particular purpose of protecting the two inactive cutting edges 52, 54 from damage.

1. A tool for machining a workpiece, comprising:
a tool holder, which extends along a holder longitudinal axis;
a cutting insert; and
a mounting element,
wherein the tool holder has a cutting insert receptacle for receiving the cutting insert, the cutting insert receptacle comprising:
a recess formed in a holder-side support surface, wherein a base of the recess is penetrated by a holder-side mounting bore, wherein a bore axis of the holder-side mounting bore extends transversely to the holder longitudinal axis and wherein the holder-side mounting bore serves to receive the mounting element for mounting the cutting insert on the tool holder, and wherein the recess is delimited laterally by two holder-side bearing surfaces arranged transversely to the base and arranged transversely to one another;
wherein the cutting insert has a plurality of identical cutting edges, which are arranged in a common cutting plane, are formed at a transition between an upper side and a peripheral side of the cutting insert, are arranged at an angular offset from one another and extend transversely to one another,
wherein the cutting insert has, on a lower side opposite the upper side, an insert-side support surface, which is arranged parallel to the cutting plane, and an extension, which projects from the insert-side support surface and, in a mounted state of the tool, is inserted in the recess,
wherein three insert-side bearing surfaces extending transversely to one another are arranged laterally on the extension, and wherein the cutting insert further comprises an insert-side mounting bore extending through the extension and penetrating the upper side and the lower side, wherein a bore axis of the mounting bore is arranged orthogonally to the cutting plane and serves to receive the mounting element,
wherein the insert-side support surface rests against the holder-side support surface in the mounted state of the tool, and wherein a first of the three insert-side support surfaces rests against a first of the two holder-side bearing surfaces in the mounted state of the tool, and a second of the three insert-side bearing surfaces rests against a second of the two holder-side bearing surfaces in the mounted state of the tool.

2. The tool according to claim 1, wherein the insert-side support surface completely surrounds the extension.

3. The tool according to claim 1, wherein the holder-side support surface completely surrounds the recess.

4. The tool according to claim 1, wherein the holder-side bearing surfaces and the insert-side bearing surfaces are each configured as a planar surface.

5. The tool according to claim 1, wherein a cross section of the extension aligned orthogonally to the bore axis of the insert-side mounting bore has substantially a shape of a regular polygon with rounded corners.

6. The tool according to claim 4, wherein a cross section of the extension aligned orthogonally to the bore axis of the insert-side mounting bore has substantially a shape of a regular polygon with rounded corners, and wherein the insert-side bearing surfaces form an angle of 60° between them.

7. The tool according to claim 1, wherein the insert-side bearing surfaces are arranged parallel to the bore axis of the insert-side mounting bore.

8. The tool according to claim 1, wherein the bore axis of the insert-side mounting bore is arranged orthogonally to the holder longitudinal axis.

9. The tool according to claim 1, wherein a height of the extension measured parallel to the bore axis of the insert-side mounting bore is smaller than a depth of the recess measured parallel to the bore axis of the holder-side mounting bore.

10. The tool according to claim 1, wherein the extension has a planar end face, which extends transversely to the insert-side bearing surfaces, is penetrated by the insert-side mounting bore and is arranged orthogonally to the bore axis of the insert-side mounting bore.

11. The tool according to claim 1, wherein a cross section of the recess aligned orthogonally to the bore axis of the holder-side mounting bore is larger than a cross section of the extension aligned orthogonally to the bore axis of the insert-side mounting bore.

12. The tool according to claim 11, wherein the two holder-side bearing surfaces are each at a first distance from the bore axis of the holder-side mounting bore, and wherein the recess is further delimited laterally by a side surface arranged transversely to the base and transversely to the two holder-side bearing surfaces, which side surface is at a second distance from the bore axis of the holder-side mounting bore that is larger than the first distance.

13. The tool according to claim 12, wherein, in the mounted state of the tool, a first of the plurality of cutting edges is arranged in a region of the cutting insert projecting laterally from the tool holder, and wherein the first cutting edge is at a shorter distance from the side surface than from the two holder-side bearing surfaces.

14. The tool according to claim 1, wherein a height of the extension measured parallel to the bore axis of the insert-side mounting bore is less than 40% of a total height of the cutting insert measured parallel thereto.

15. The tool according to claim 1, wherein the cutting insert receptacle is arranged in a cut-out provided on the tool holder, which cut-out has a side wall, which partially surrounds the holder-side support surface, is arranged transversely to the holder-side support surface and, in the mounted state of the tool, surrounds two of the plurality of cutting edges of the cutting insert.
